(19) United States
(12) Patent Application Publication
(10) Pub. No.: US 2021/0009107 A1
(43) Pub. Date: Jan. 14, 2021

(54) METHOD FOR OPERATING A DRIVER ASSISTANCE SYSTEM AND VEHICLE COMPRISING A DRIVER ASSISTANCE SYSTEM DESIGNED TO CARRY OUT THE METHOD

(71) Applicant: DAIMLER AG, Stuttgart (DE)

(72) Inventors: Florian RIES, Stuttgart (DE); Frank SCHUSTER, Böblingen (DE); Martin HAUEIS, Gärtringen (DE); Mohammad GHANAAT, Stuttgart (DE); Florian GEIß, Grafenau (DE); Jochen ROTH, Weil der Stadt (DE)

(73) Assignee: DAIMLER AG, Stuttgart (DE)

(21) Appl. No.: 16/608,309

(22) PCT Filed: Apr. 17, 2018
(86) PCT No.: PCT/EP2018/059721

§ 371 Date: Oct. 25, 2019

(30) Foreign Application Priority Data
Apr. 27, 2017 (DE) 10 2017 004 118.0

(51) Int. Cl. B60W 30/00; G01C 21/30; G01C 21/00; G01S 19/42; B60W 60/00; G01C 21/36; G01S 13/931

(52) U.S. Cl. CPC B60W 30/00; G01C 21/30; G01C 21/3815; G01S 19/42; G01C 21/3841; B60W 2554/20; G01C 21/3691; G01S 13/931; B60W 2552/53; B60W 2530/00; B60W 60/001

(57) ABSTRACT

A method for operating a driver assistance system of a vehicle involves, for determining a position of the vehicle in a digital environment map, detecting environment data for the vehicle using an on-board sensor system and matched with map data stored in the environment map. A position of the vehicle in a real environment is determined using position data of the vehicle from an on-board satellite receiver. Accuracy of the determined position of the vehicle is determined based on the position data and environment data matched with the environment data. Accuracy is predicted with which the position of the vehicle in the environment map can be determined for a predetermined section of road ahead of the vehicle. Fully automated operation of the vehicle is enabled when the determined accuracy and the predicted accuracy for the predetermined section of road ahead of the vehicle are greater than at least one accuracy threshold.

### BACKGROUND AND SUMMARY OF THE INVENTION

Exemplary embodiments of the invention relate to a method for operating a driver assistance system.

Methods for operating a driver assistance system by means of which partially and/or fully automated operation of a vehicle is possible are known from the prior art. For example, DE 10 2011 119 762 A1 describes a method for determining the position of a motor vehicle and a position-determining system suitable for the motor vehicle. The system comprises a digital map in which data on location-specific features, also called landmarks, are recorded in a localized manner, at least one environment-recognition device for detecting the location-specific features in the surroundings of the vehicle, and a geolocation module coupled to the digital map and the environment-recognition device. The geolocation module comprises a processing unit for matching the detected data and the data recorded in the digital map by means of the location-specific features and for geolocating the vehicle position based on the location-specific features recorded in the digital map in a localized manner. The system further comprises an inertial measurement unit for vehicle motion data that is coupled to the geolocation module, the processing unit of which is configured to determine the vehicle position using vehicle motion data based on the position located on the basis of the location-specific features.

The problem addressed by the invention is to provide an improved method for operating a driver assistance system compared with the prior art and to provide a vehicle in which the method is used.

In a method for operating a driver assistance system for a vehicle, environment data for the vehicle are detected by means of an on-board sensor system and matched with map data stored in the environment map to determine a position of the vehicle in a digital environment map. For determining a position of the vehicle in a real environment, position data of the vehicle are determined by means of at least one on-board satellite receiver. Furthermore, an accuracy of the determined position is determined based on the position data and based on environment data matched with the environment data. In order to determine the accuracy, the position data and the matched environment data are preferably fed to a position filter, the position of the vehicle in the environment map being matched with the actual position of the vehicle by means of the position filter and the plausibility of the position of the vehicle in the map in particular being checked by means of the matching. Furthermore, fully automated operation of the vehicle is enabled on the basis of the determined accuracy. Fully automated operation is understood to mean highly automated operation or autonomous operation here.

According to the invention, it is provided that an accuracy is predicted with which the position of the vehicle in the environment map can be determined for a predetermined section of road ahead of the vehicle. Fully automated operation of the vehicle is then enabled, i.e., the vehicle can only be operated in a fully automated manner, when the determined accuracy and the predicted accuracy for the predetermined section of road ahead of the vehicle meet the predetermined requirements, i.e., are greater than at least one accuracy threshold. Preferably, it remains enabled only for as long as the requirements for accuracy are met. That is, the fully automated operation of the vehicle is terminated when the conditions for enabling fully automated operation are no longer met.

The at least one predetermined accuracy threshold is preferably predetermined based on the section of road ahead of the vehicle, in particular based on the curvature and/or the lane width of the section of road ahead of the vehicle. The requirements for the accuracy of the position determination can thus be adapted to the section of road ahead of the vehicle. To enable fully automated operation on a winding section of road with narrow lanes, higher requirements can therefore be placed on the accuracy of the position determination than for operation on a straight section of road with wide lanes.

By means of the method, longer fully automated journeys with fewer interruptions are possible compared with conventional methods. This enhances the quality of the experience of fully automated driving for the driver. By matching the predicted accuracy as well as the threshold, which corresponds to a requirement on the accuracy of the position determination in the section of road ahead of the vehicle, availability of fully automated operation of the vehicle for a certain time can be planned in advance. The threshold for the accuracy of the position of the vehicle in the environment map is predicted, in particular, based on a lane course, a lane width and/or desired or predetermined driving speeds. For example, the threshold for the accuracy for a curved lane course is lower than for a straight lane course. Advanced planning of the availability of the fully automated operation of the vehicle also allows for extending the time available for the driver to manually take back control of the operation of the vehicle.

### BRIEF DESCRIPTION OF THE DRAWING FIGURE

Embodiments of the invention are explained in more detail below with reference to a drawing,

in which:

FIG. 1 schematically shows a vehicle comprising a driver assistance system.

### DETAILED DESCRIPTION

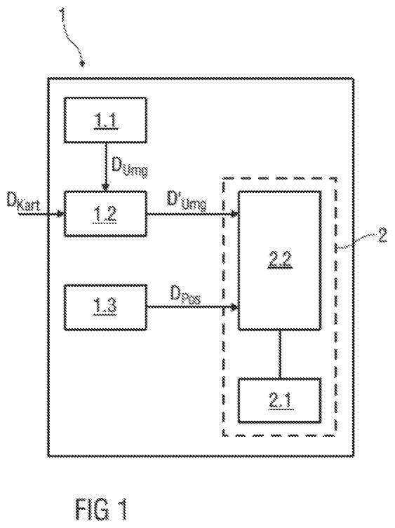

The single figure, FIG. 1, shows a block diagram of a vehicle 1 comprising a driver assistance system 2 in one embodiment.

The driver assistance system 2 is designed for carrying out partially and fully automated operation of the vehicle 1 and comprises a control unit 2.1, by means of which the partially and fully automated operation can be activated, deactivated, and carried out upon activation. For this purpose, the control unit 2.1 is coupled to an on-board sensor system 1.1, by means of which environment data D_{Umg} of the vehicle 1 are detected. The on-board sensor system 1.1 includes, for example, lidar sensors, radar sensors, ultrasound sensors, and/or infrared sensors, which have a limited detection range.

By means of the on-board sensor technology 1.1, map data D_{Kart} stored in a digital environment map and including landmarks and lane characteristics can be recognized during a journey in a vehicle environment and matched with the map data D_{Kart}. This process is commonly referred to as matching. In this process, it is determined at which position in the environment map the detected environment data D_{Umg} correspond to map data D_{Kart} stored in the environment map. Those environment data from the set of the map data D_{Kart} corresponding to the detected environment data D_{Umg} are hereinafter referred to as matched environment data D′_{Umg}. In the environment map, map data D_{Kart} are stored via location-specific features, in particular landmarks, and lane properties, which are assigned to a local, geographical position. Road signs, telegraph poles or other objects can be stored as landmarks, for example. The environment map can be stored in a navigation device 1.2 of the vehicle 1, usually only a section of the environment map being stored in the vehicle 1 that includes a section of road ahead of the vehicle. By matching the detected environment data D_{Umg} with the stored map data D_{Kart}, a position of the vehicle 1 in the environment map can be determined.

In the present embodiment, the vehicle 1 further comprises a satellite receiver 1.3, e.g., what is known as a GNSS (global navigation satellite system) receiver, by means of which position data D_{Pos} of the vehicle 1 in a real environment are received.

For a plausibility check of the position of the vehicle 1 in the environment map, the position data D_{Pos} of the vehicle 1 and environment data D′_{Umg} matched with the map data D_{Kart} are transmitted to a position filter 2.2. In addition, odometry data can be transmitted to the position filter 2.2. The position filter 2.2 is part of the driver assistance system 2 and is designed as, for example, a Kalman filter. Based on the plausibility check of the position of the vehicle 1 by means of the position filter 2.2, the position of the vehicle 1 in the environment map with the highest probability can be determined. Furthermore, the position filter 2.2 can determine an accuracy of the determined position of the vehicle 1 in the environment map on the basis of the supplied data D_{Pos}, D_{Kart}.

High accuracy of the determined position of the vehicle 1 in the environment map is obligatory for activating the fully automated operation of the vehicle 1. In other words, if the accuracy of the determined position of the vehicle 1 falls below a predetermined threshold, the fully automated operation of the vehicle 1 is not activated or deactivated. This results from the fact that for a fully automated operation of the vehicle 1, extensive knowledge of the environment of the vehicle 1 that goes beyond a detection range of the on-board sensor system 1.1 is required. In particular, the knowledge of a precise lane course in a section of road ahead of the vehicle 1 is of fundamental importance for safely carrying out fully automated braking and evasive maneuvers.

It is possible for the accuracy to fall below the threshold, for example if there is low signal quality of the received position data D_{Pos} and/or if there is too low a number of prominent landmarks in the environment. As a result, safety-related interruptions to the fully automated operation of the vehicle 1 take place in which a driver must manually take over the operation of the vehicle 1. However, the threshold for certain sections of road, in particular lane courses, may be predetermined to be higher than required. Furthermore, the threshold may vary depending on a lane width and/or desired or predetermined driving speeds. For example, it may be that the fully automated operation of the vehicle 1 is interrupted on a straight lane course, and a lower accuracy would be required at least for lateral guidance of the vehicle 1 than for a lane with bends. There is usually only a short period of time available to take over the manual operation of the vehicle 1, and therefore, even in fully automated operation, the driver must always pay attention and be ready to take over operation.

To increase the quality of the experience of the fully automated driving operation for the driver, the accuracy of the position of the vehicle 1 in the environment map for a predetermined section of road ahead of the vehicle 1 and at least one threshold for the accuracy for enabling the fully automated operation of the vehicle 1 are predicted.

For predicting the accuracy of the position of the vehicle 1, on one hand, an accuracy of the position of the vehicle 1 in the real environment is predicted. In particular, based on location-specific features in the environment map, a reception quality, i.e., expected signal quality of position data D_{Pos} to be received, is estimated. Reception quality can be reduced, for example, on overpasses, in the event of multipath effects of vertical structures, etc. This reduces the accuracy of the determined position of the vehicle 1 in the environment map.

In order to predict the accuracy of the position of the vehicle 1 in the real environment, a test drive through the section of road ahead of the vehicle, for example for a predetermined number of kilometers, is first simulated starting from the current position of the vehicle 1 and a current satellite constellation of the global navigation satellite system. If there are overpasses and/or vertical structures alongside or on the carriageway during the simulated test drive, the expected influence on the effects on the reception quality of the position data D_{Pos} is evaluated. For predicting the accuracy of the position of the vehicle 1 in the real environment, a simplified simulation model is used here.

For predicting the accuracy of the position of the vehicle 1, on the other hand, an accuracy of the position of the vehicle 1 that has been determined in the environment map and has not yet been checked for plausibility is predicted. This accuracy depends on a spatial density of the landmarks stored in the environment map. Here, a test drive through the section of road ahead of the vehicle, for example for a predetermined number of kilometers, is simulated starting from the current position of the vehicle 1 and a current state of the position filter 2.2. As part of this simulation, virtual sensor data are generated on the basis of the landmarks. A simplified model of the position filter 2.2 uses the virtual sensor data to estimate the evolution of the accuracy of the position of the vehicle 1 in the section of road, in particular the map section, ahead of the vehicle.

For predicting the at least one threshold, the map data D_{Kart} comprising the section of road ahead of the vehicle are analyzed with regard to a lane course, a lane width and/or with regard to desired or predetermined driving speeds. The section of road for example has a length of 200 meters, starting from a current viewing point. The accuracy of the prediction depends on the particular application.

By matching the predicted accuracy for the position of the vehicle 1 in the environment map and the threshold, the availability of the fully automated operation of the vehicle 1 for a certain time can be planned in advance. This allows the time available for the driver to manually take back control of the operation of the vehicle to be extended and enhances the quality of the experience of fully automated driving for the driver.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for operating a driver assistance system of a vehicle, the method comprising:
determining a position of the vehicle in a digital environment map by
detecting, using an on-board sensor system of the vehicle, first environment data for the vehicle; and
matching the detected environment data with map data stored in the digital environment map;
determining a position of the vehicle in a real environment by determining, using an on-board satellite receiver, position data of the vehicle;
determining an accuracy of the determined position of the vehicle based on the position data and second environment data matched with the first environment data;
predicting an accuracy with which the position of the vehicle in the digital environment map can be determined for a predetermined section of road ahead of the vehicle; and
enabling fully automated operation of the vehicle responsive to the determined accuracy and the predicted accuracy for the predetermined section of road ahead of the vehicle are greater than at least one accuracy threshold.

12. The method of claim 11, wherein the at least one accuracy threshold is predetermined based on the section of road ahead of the vehicle.

13. The method of claim 11, further comprising:
supplying the position data and the second environment data to a position filter,
wherein plausibility of the determined position of the vehicle is checked by the position filter and the accuracy of the determined position is determined.

14. The method of claim 13, wherein the prediction of the accuracy with which the position of the vehicle in the digital environment map can be determined involves starting from a current position of the vehicle and a current state of the position filter and simulating a journey through the section of road ahead of the vehicle.

15. The method of claim 13, wherein during the simulation of the journey, virtual sensor data are generated based on the map data, and a curve for an accuracy for determining the position of the vehicle in the section of road ahead of the vehicle is predicted based on the virtual sensor data.

16. The method of claim 13, wherein the prediction of the accuracy with which the position of the vehicle in the digital environment map can be determined involves starting from a current position of the vehicle and a current satellite constellation of a global navigation satellite system, and simulating an onward journey through the section of road ahead of the vehicle.

17. The method of claim 16, wherein virtual landmarks that are passed during the simulated onward journey are detected, a curve for reception quality for receiving the position data is predicted based on the detected landmarks.

18. The method of claim 11, wherein the prediction of the at least one accuracy threshold involves analyzing the map data comprising the section of road ahead of the vehicle with regard to a lane course, a lane width and/or desired or predetermined driving speeds.

19. The method of claim 11, wherein the fully automated operation of the vehicle only remains enabled for as long as the determined accuracy and the predicted accuracy are greater than the at least one accuracy threshold.

20. A vehicle, comprising:
a driver assistance system, which includes an on-board sensor system and an on-board satellite receiver, wherein the driver assistance system is configured to
determine a position of the vehicle in a digital environment map by
detecting, using the on-board sensor system of the vehicle, first environment data for the vehicle; and
matching the detected environment data with map data stored in the digital environment map;
determine a position of the vehicle in a real environment by determining, using the on-board satellite receiver, position data of the vehicle;
determine an accuracy of the determined position of the vehicle based on the position data and second environment data matched with the first environment data;
predict an accuracy with which the position of the vehicle in the digital environment map can be determined for a predetermined section of road ahead of the vehicle; and
enable fully automated operation of the vehicle responsive to the determined accuracy and the predicted accuracy for the predetermined section of road ahead of the vehicle are greater than at least one accuracy threshold.
